(19) United States
(12) Patent Application Publication
(10) Pub. No.: US 2019/0233690 A1
(43) Pub. Date: Aug. 1, 2019

(54) CHITOSAN-REINFORCED UREA-FORMALDEHYDE ADHESIVES FOR WOOD COMPOSITE MANUFACTURING

(71) Applicant: FPInnovations, Pointe-Claire (CA)

(72) Inventors: Xiang-Ming WANG, Québec (CA); Dian-Qing YANG, Quebec (CA); Yaolin ZHANG, Quebec (CA); Martin FENG, Vancouver (CA); Guangbo HE, New Westminster (CA); Stéphan RAYMOND, Quebec (CA)

(73) Assignee: FPInnovations, Pointe-Claire, QC (CA)

(21) Appl. No.: 16/335,751

(22) PCT Filed: Sep. 18, 2017
(86) PCT No.: PCT/CA2017/051094

§ 371 Date: Mar. 22, 2019

Related U.S. Application Data
(60) Provisional application No. 62/398,008, filed on Sep. 22, 2016.

(51) Int. Cl. C09J 161/24; C09J 105/08; C09J 11/08

(52) U.S. Cl. CPC C09J 161/24; C08L 31/04; C09J 11/08; C09J 105/08

(57) ABSTRACT

It is disclosed chitosan-reinforced urea-formaldehyde (UF) adhesives for bonding wood-based composites, such as plywood and particleboard, or other fibrous materials and the method of producing the adhesives. The adhesives are produced by mixing unmodified chitosan containing raw material and a urea-formaldehyde resin to produce wood composite adhesive resins.

### TECHNICAL FIELD

It is provided adhesive resin comprising unmodified chitosan and an urea-formaldehyde (UF) resin.

### BACKGROUND OF THE INVENTION

Urea-formaldehyde (UF) adhesives are made of unsubstituted urea and formaldehyde and are currently used as binders for manufacturing wood composites. The most common applications of UF adhesives are in the manufacture of plywood, particleboard and medium density fibreboard (MDF) for interior uses. Exterior grade panels often employ phenol-formaldehyde (PF) adhesives that meet the requirements for extreme conditions of moisture and temperature. However, the cost of PF adhesive is at least twice as much as that of UF adhesive. In order to improve bonding quality and reduce cost of plywood products, UF adhesives are usually incorporated with fillers or extenders to increase their viscosity (thickness) and reduce penetration into the wood tissue. Wheat flour is the most common extender (filler) used in the plywood manufacturing. Level of wheat flour used as an extender in UF adhesives is normally from 15% to 50% based on resin solids. Wheat flour is a main food resource of human being and the large amount of utilization of wheat flour in the wood composite industry will increase agricultural burden of earth and increase food price. In addition, high level (more than 30%) of wheat flour used in a UF resin also lowers water resistance and physical and mechanical properties of plywood products.

Wood-based composites are made of different types of wood materials glued with adhesives into structural or non-structural panels. Currently, the main types of wood adhesives used are formaldehyde-based resins, such as urea-formaldehyde (UF), phenol-formaldehyde (PF) and melamine-formaldehyde (MF) resins.

There is still a need to be provided with novel types of adhesives for green composite panel production from renewable natural resource that reduces environmental impact from composite products. It would be highly desirable to be provided with adhesives produced with low-formaldehyde or free of formaldehyde that have excellent performance and low cost.

### SUMMARY OF THE INVENTION

It is provided an adhesive resin comprising unmodified chitosan; and an urea-formaldehyde (UF) resin.

In an embodiment, the adhesive resin described herein further comprises wheat flour.

In another embodiment, the adhesive resin described herein further comprises a catalyst.

In a further embodiment, the adhesive resin described herein further comprises phenol-formaldehyde (PF) or melamine-formaldehyde (MF).

In an additional embodiment, the adhesive resin described herein further comprises polyvinyl acetate (PVA) adhesives.

In an additional embodiment, the adhesive resin described herein further comprises two parts of the 2% chitosan solution (w/v) for one part of UF resin (weight to weight).

In an embodiment, the adhesive resin described herein further comprises one part (weight to weight) of 2% chitosan solution (w/v) for two parts of UF resin.

In another embodiment, the adhesive resin described herein further comprises a ratio of 1:2 or 2:1 of chitosan-UF resin.

In another embodiment, the adhesive resin described herein further comprises one part (volume to volume) of chitosan in solution (2% w/v) for three parts of a liquid UF resin.

In a further embodiment, the catalyst is NH₄Cl.

In another embodiment, the chitosan is from shells of marine crustaceans or from cell wall of fungi.

In another embodiment, the crustaceans are crabs, lobsters or shrimps.

In a further embodiment, the resin comprises a viscosity of up to 900 CP.

It is also provided a plywood panel comprising the adhesive resin encompassed herein.

In an embodiment, the plywood panel comprises a strength of up to 6809 kPa.

It is further provided a particleboard comprising the adhesive resin described herein.

It is also provided a fibrous material comprising the adhesive resin described herein.

In an embodiment, the fibrous material is a paper, wood, plywood, strandboard, particleboard, fibreboard or a combination thereof.

It is further provided a method of producing an adhesive resin comprising dissolving chitosan in an acid to produce a chitosan solution; and mixing the chitosan solution to an urea-formaldehyde (UF) resin.

In an embodiment, the chitosan is dissolved in acetic acid.

In a further embodiment, 2% (w/v) of chitosan is dissolved in 2-10% (v/v) 1N acetic acid aqueous solution (in other word, 2% of chitosan is dissolved in ˜0.1%-0.6% acetic acid aqueous solution (w/v)).

### BRIEF DESCRIPTION OF THE DRAWINGS

Reference will now be made to the accompanying drawings.

FIG. 1 illustrates a block diagram of a method for producing an adhesive according to one embodiment.

FIG. 2 illustrates a histogram showing two-ply plywood panels shear strength with lower and higher glue spread rates in (A) dry test and (B) wet test conditions.

FIG. 3 illustrates a histogram showing three-ply plywood shear strength tested under dry and wet conditions.

FIG. 4 illustrates a histogram showing the thickness swelling (A) and internal bond strength (B) properties of particleboard tested.

FIG. 5 illustrates a histogram showing the static bending properties (modulus of rupture (A) and modulus of elasticity (B)) of particleboard tested.

### DETAILED DESCRIPTION OF THE PREFERRED EMBODIMENT

In accordance with the present invention, there is provided adhesive resin comprising unmodified chitosan and a urea-formaldehyde (UF) resin.

It is disclosed a chitosan-reinforced urea-formaldehyde (UF) adhesive for bonding wood-based composites, such as plywood and particleboard, or other fibrous materials and the method of producing the adhesives. The adhesives described herein are produced by mixing a chitosan containing raw material and a urea-formaldehyde resin to produce wood composite adhesive resins with desirable viscosity, improved bonding quality and better water resistance for reduced resin consumption of composite panel manufacturing.

The glue formulation encompassed herein for plywood comprises:
UF+unmodified chitosan; or
UF+unmodified chitosan+wheat flour+a catalyst.

In an embodiment, the adhesive resin described herein can further comprise phenol-formaldehyde (PF) or melamine-formaldehyde (MF).

In another embodiment, the adhesive resin described herein can further comprise polyvinyl acetate (PVA) adhesives.

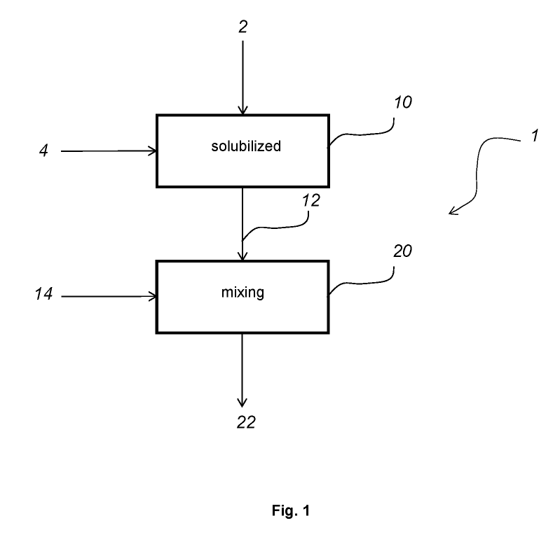

Referring now to FIG. 1 wherein it is shown a block diagram of a method (1) for producing an adhesive resin for binding fibrous materials. Fibrous materials are understood to comprise various cellulosic materials that include but are not limited to: paper, wood, plywood, strandboard, particleboard, fibreboard and combinations thereof.

The method (1) for producing an adhesive resin starts with providing a chitosan containing raw material (2).

Chitosan is an amino polysaccharide deacetylated from chitin, which is naturally occurring in large amount in shells of marine crustaceans such as crabs and shrimps and in cell wall of fungi. The chemical structure of chitosan consists of β-1,4-linked D-glucosamine residues with a number of randomly located N-acetyl-glucosamine. Chitosan is an amino polysaccharide obtained by partial to substantial alkaline N-deacetylation of chitin also named poly(N-acetyl-D-glucosamine), which is a naturally occurring biopolymer found in exoskeleton of crustaceans, such as shrimp, crab and lobster shells. Chitosan contains free amine (—NH₂) groups and may be characterized by the proportion of N-acetyl-D-glucosamine units and D-glucosamine units, which is expressed as the degree of deacetylation (DDA) of the fully acetylated polymer chitin. The properties of chitosan, such as the solubility and the viscosity, are influenced by the degree of deacetylation (DDA), which represents the percentage of deacetylated monomers, and the average molecular weight (Mw).

Chitosan is soluble in weakly acidic aqueous solutions and presents in a cationic polyelectrolyte form, which creates the possibility for interactions with negatively charged molecules. In other words, chitosan possesses adhesive properties.

Chitosan has received much attention as a potential polysaccharide resource in various fields, and it has been studied extensively for medical and industrial applications.

The chitosan raw material (2) is dissolved/solubilized (10) in an acid (4) to produce a chitosan solution (12). In an embodiment, chitosan is solubilized in for example 2-10% (w/v) 1N acetic acid (˜0.1%-0.6% acetic acid aqueous solution). Chitosan can be dissolved in the acid aqueous solution with gentle stirring. In an embodiment, 2% (w/v) of chitosan is dissolved in 2-10% (v/v) 1N acetic acid (˜0.1%-0.6% acetic acid aqueous solution). Vigorous stirring produced many small bubbles in the solution, and these bubbles required minimal 12 hours to be settled down.

The chitosan solution (12) is then added and mixed (20) to a urea-formaldehyde (UF) resin (14) to produce a chitosan-reinforced urea-formaldehyde adhesive (22).

In an embodiment, two parts of the 2% chitosan solution can be added to one part of a UF resin (weight to weight). In another embodiment, one part (weight to weight) of the 2% chitosan solution can be added to two parts of a UF resin.

Exoskeletons of crustaceans, such shrimp, crab and lobster shells are usually the source of commercial chitosan. In a preferred embodiment the chitosan containing starting material encompassed herein derives from a marine source such as shrimp or crustacean shells or fungi.

Dutkiewicz et al. (1984, J. Appl. Polym. Sci., 29: 45-55) describes methods of mixing several polymers as formaldehyde scavengers into to a urea-formaldehyde (UF) resin for reducing formaldehyde emission from the cured resin. Among disclosed formaldehyde scavengers, polymethacrylamide and chitosan did not inhibit formaldehyde release compared to other three investigated.

Verville et al. (U.S. Pat. No. 8,747,539) disclosed an hydrolyzed chitosan as an adhesive for making wood-based composite panels. The chitosan is hydrolyzed by acid for 8-12 hours before usage. The adhesive is reinforced by a crosslinking agent which is chosen from phenylglyoxal, hexylglyoxal, benzoquinone, t-butylbenzoquinone, and mixtures thereof, in which ratio of crosslinking agent to chitosan is about 1:15-30.

U.S. Pat. No. 8,562,731 discloses a fungal modified chitosan-based adhesive for binding a fibrous material and the method of producing the adhesive. It is disclosed the modification of chitosan with a biological approach for wood adhesive application. This patent also revealed that bio-modified chitosan can be used to enhance the bond quality of UF and PF resins to make them stronger binders for manufacturing wood composites.

The present disclosure includes a method to formulate unmodified chitosan as an enhancer in urea-formaldehyde (UF) resins and a production process for manufacturing plywood panels with chitosan-reinforced UF resins.

It is provided methods and manufacturing process using a small amount of chitosan (less than 1%) in a UF resin to replace wheat flour as an extender for increasing resin viscosity (thickening) and reducing extensive resin consumption.

Accordingly, by the process described herein, the water resistance and bonding properties of wood composite products is increased, allowing the use of such product in potential humid environmental conditions, such as flooring.

As shown hereinbelow, the strength of 2-ply plywood panels made with the UF resin at different spread rates were between 3591 to 4479 kPa. The strength of the panels made with the chitosan-reinforced UF resin at the ratio of 1:2 of 2% chitosan solution to the UF resin with similar spread rates as the UF resin increased to 5235-6547 kPa. Whereas the strength of the panels made with the chitosan-reinforced UF resin at the ratio of 2:1 of 2% chitosan solution to the UF resin with half of spread rates as the UF resin further increased to 5632-6809 kPa.

Under wet conditions, the strength of 2-ply plywood panels made with the UF resin at different spread rates was low; between 1599 and 2311 kPa. The strength of the panels made with the chitosan-reinforced UF resin at the ratio of 1:2 of 2% chitosan solution to the UF resin with similar spread rates as the UF resin increased to 4375-5456 kPa. The strength of the panels made with the chitosan-reinforced UF resin at the ratio of 2:1 of 2% chitosan solution to the UF resin with half of spread rates as UF resin reached to 3782-5088 kPa. Accordingly, the water resistance of the UF resin is much improved by after chitosan incorporated in it.

By adding chitosan in UF resins, the viscosity of the resin mixtures is significantly increased. The water resistance of the UF resin is also improved by adding chitosan inside the formulations.

As disclosed herein, a small quantity of chitosan solution with a 2% concentration was added into a commercial urea-formaldehyde (UF) resin via post-blending to improve its tacking property in the manufacture of particleboard. Good initial adhesion (tack) of urea-formaldehyde (UF) resin is important for keeping the mat integrity during forming and transportation to the hot press, while poor tacking of UF resin normally results in increased rejection rate of panels because of surface cracks. It was found that adding 1 part of 2% chitosan solution into 3 parts of liquid UF resin, corresponding to 0.66 wt % solid chitosan in the liquid resin, can improve the resin tack by 28% in terms of particleboard mat falling distance.

Panels made of UF resin plus 0.99% chitosan powder and 1% catalyst (NH₄Cl) as face resin and UF resin plus 0.95% chitosan powder and 2% catalyst (NH₄Cl) as core resin have the best physical and mechanical properties and lowest rates of water absorption and thickness swelling.

Accordingly, it is described the use of unmodified chitosan to reinforce commercial UF resins designed for plywood panels and particleboard, respectively. As shown herein it improves UF resin bond strength and durability in plywood manufacturing; improves UF resin bond strength and durability in particleboard manufacturing; and improves UF resin tack property in particleboard manufacturing.

The present disclosure will be more readily understood by referring to the following examples which are given to illustrate the invention rather than to limit its scope.

### Example I

### Preparation of Chitosan Aqueous Solutions

The chitosan used in this test was obtained from Marinard Biotech of Rivière-au-Renard, Quebec. The characteristics of this product are shown in Table 1.

TABLE 1
Characteristics of commercial chitosan used in the test

| Parameter | Characteristics | |
|---|---|---|
| Appearance | Off-white | |
| Form | Flake | |
| Moisture | 5.6% | |
| Ash | 0.197% | |
| Protein | <0.2% | |
| Insoluble matter | <1% | |
| Degree of deacetylation | 86.6% | |
| Toxic heavy metals (As, Cd, Hg, Pb) | <5 | ppm |
| Viscosity (1% wt in 1% acetic acid) | 307 | cps |
| Microbial contamination | 890 | CFU/g |

Chitosan appears as white flakes and is soluble in dilute acids such as acetic acid or formic acid. Most literatures recorded that chitosan is soluble in 1% (w/v) acetic acid. However, different concentrations of the acids will affect the pH, solubility and viscosity of chitosan solution. In order to find a best concentration of the acid that could produce a suitable chitosan solution, a series of dilutions from 1N acetic acid solution, i.e. 1%, 2%, 4%, 6%, 8% and 10% (v/v), were made with sterile distilled water. The different concentrations of chitosan in the acid solutions were prepared by 1%, 2% and 4% (w/v), and the chitosan solutions were stirred with or without heating for 30 min.

The results of this test showed that 1% (v/v) of 1N acetic acid (˜0.06% acetic acid aqueous solution) was unable to dissolve chitosan, and 2-4% (v/v) of the acid (˜0.1%-0.3% acetic acid aqueous solution) partially dissolved chitosan to form a milky solution. The solution of 6% (v/v) 1N acetic acid (˜0.4% acetic acid aqueous solution) was able to totally dissolve 2% of chitosan (w/v), and 8-10% (v/v) of the acid (˜0.5%-0.6% acetic acid aqueous solution) dissolved 4% of chitosan (w/v). A clear transparent chitosan liquid could be produced with 10% (v/v) of 1N acetic acid aqueous solution (˜0.6% acetic acid aqueous solution). Heat did not help to dissolve chitosan, but a gentle stirring was required. Vigorous stirring produced many small bubbles in the solution, and these bubbles required minimal 12 hours to be settled down.

The pH and viscosity of chitosan solution made with 10% (v/v) of 1N acetic acid (˜0.6% acetic acid aqueous solution as medium increased along with the increase of chitosan content in the solution. At room temperature (around 20° C.), the pH of 1% of chitosan solution (w/v) was 3.97 with a viscosity of 300 cps, whereas that of 2% of chitosan solution (w/v) was 4.77 with a viscosity of 2300 cps, and that of 4% (w/v) of chitosan solution was 5.53 with an immeasurable viscosity (Table 2).

TABLE 2
pH and viscosity of chitosan solutions

| | | | | 10% |
|---|---|---|---|---|
| | | | | of 1N |
| | | | | Acetate |
| | | | | Acid |
| | Concentration of Chitosan Solution | | | Solution |
| Parameter | (w/v) | | | (w/v) |
| Solid content (%) | 1.6 | 2.6 | 4.6 | 0.6 |
| Acetate acid content (%) | 0.6 | 0.6 | 0.6 | 0.6 |
| Chitosan content (%) | 1 | 2 | 4 | 0 |
| pH | 3.97 | 4.77 | 5.53 | 2.88 |
| Viscosity (cps, 20° C.) | 300 | 2300 | >>10000 | 1 |

### Example II

### Formulation of Chitosan-Reinforced Resin Mixes without the Use of Wheat Flour and Catalyst

The UF resin solid content is 66.8% with a pH of 6.95.

Two types of chitosan-reinforced urea-formaldehyde adhesive mixtures were prepared with chitosan solution and a urea-formaldehyde resin as described above.
1) Two parts of the 2% chitosan solution (w/v) were slowly added to one part of the UF resin (weight to weight), gently stirred for 1 h at room temperature, and then sit at 4° C. for 24 h. The solids content of this adhesive mixture was 24.0% and the pH value was 4.92. The chitosan content is 5.7% wt. of the solid of the mixture, and 1.3% wt. of total weight of resin mixture.
2) One part of the 2% chitosan solution (w/v) was slowly added to two parts of the UF resin (weight to weight), gently stirred for 1 h at room temperature, and then sit at 4° C. for 24 h. The solids content of this adhesive mixture was 45.4% and the pH value was 5.33. The chitosan content is 1.5% wt. of the solid of the mixture, and 0.7% wt. of total weight of the resin mixture.

The changes in pH and viscosity of UF resin were observed after mixing with chitosan solution (Table 3). The pH of the 2% chitosan solution (w/v) was 4.77, whereas that of UF resin was 6.95. After adding one part of the 2% chitosan solution to two parts of the UF resin, the pH decreased to 5.33. Contrary to pH, after adding one part of the 2% chitosan solution to two parts of the UF resin, the viscosity increased from 230 CP to about 900 CP.

TABLE 3
pH and viscosity of chitosan-reinforced UF mixture

| | | | | UF-10% |
|---|---|---|---|---|
| | | | | 1N |
| | UF-2% Chitosan | | UF-2% Chitosan | Acetate |
| | solution mixture | UF | solution Mixture | Acid 2:1 |
| Character | 1:2 (w/w) | Resin | 2:1 (w/w) | (wt/wt) |
| pH | 4.92 | 6.95 | 5.33 | 3.71 |
| Viscosity | 1880 | 230 | 900 | 17 |
| (CP, 25° C.) | | | | |

### Example III

### Testing of 2-Ply Plywood Panels Made with the Adhesive Mixtures

Yellow birch veneer strips (1.5 mm thick×148 mm wide×313 mm long) were cut from fresh yellow birch logs with the long direction being parallel to the wood grains. Two pieces of the veneer strips were brushed with an adhesive mix based on the resin solids content, and different spread rates were applied to make 2-ply plywood panels under conditions shown in Table 4. The 2 plies were stacked together after a proper open assembly time and then hot-pressed at 140° C. for 3 minutes. The applied pressure to veneer strips was 1500 kPa (Table 5). After manufacturing, the panels were conditioned at 21° C. and 50% relative humidity (RH) until reaching equilibrium moisture content (EMC). These 2-ply plywood samples were then cut into testing specimens (25 mm wide×80 mm long) for lap-shear test. The lap-shear strengths of these samples were determined by a MTS Alliance RT/50 testing machine with a crosshead speed of 1 mm per minute according to the standard method of CSA 0112.0, in both dry and wet conditions. For the wet test condition, specimens were soaked in tap water for 48 hours at room temperature, and then tested according to the same lap-shear method. Twelve specimens cut from 2 plywood samples were tested for each resin system, and the shear strength of plywood samples made with each resin system was obtain from an average of the 12 specimens tested.

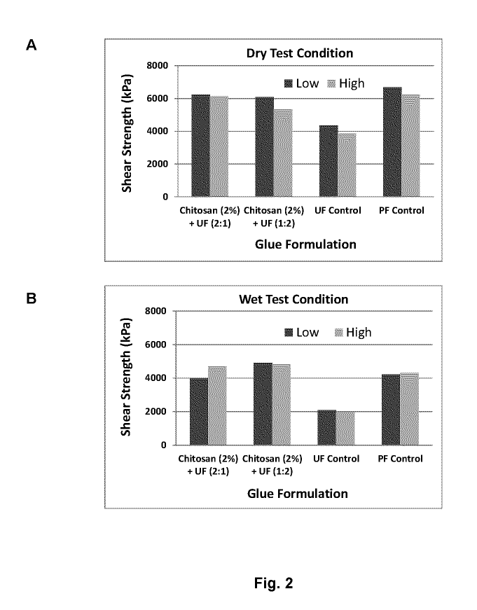

The dry and wet lap-shear strengths of 2-ply plywood panels made with lower and higher glue spread rates are summarized in Table 6 and Table 7 and FIGS. 2A and 2B, respectively. It can be seen that all dry strengths of 2-ply plywood panels were much higher than wet strengths, and both dry and wet strengths of the plywood panels made with the UF resin (J) were inferior to those panels made with the PF resin (L). With addition of chitosan in the UF resin (G and H), both dry and wet strengths of 2-ply plywood were improved to similar levels as those panels made with the PF resin.

Under the dry conditions, the strength of 2-ply plywood panels made with the UF resin at different spread rates were between 3591 and 4479 kPa (Table 6). The strength of the panels made with the chitosan-reinforced UF resin at the ratio of 1:2 with similar spread rates as the UF resin increased to 5235-6547 kPa. Whereas the strength of the panels made with the chitosan-reinforced UF resin at the ratio of 2:1 with half of spread rates as the UF resin further increased to 5632-6809 kPa.

Under the wet conditions, the strength of 2-ply plywood panels made with the UF resin at different spread rates was low; between 1599 and 2311 kPa (Table 7). The strength of the panels made with the chitosan-reinforced UF resin at the ratio of 1:2 with similar spread rates as the UF resin increased to 4375-5456 kPa. The strength of the panels made with the chitosan-reinforced UF resin at the ratio of 2:1 with half of spread rates as UF resin reached to 3782-5088 kPa. These data indicated that water resistance of the UF resin is much improved by after chitosan incorporated in it.

TABLE 4
Glue application on 2-ply plywood panels made with different types of resins

| | | | Glue Mass | Average Glue | Average Glue | | |
|---|---|---|---|---|---|---|---|
| | | | on Face | Spread per | Spread per | | |
| | | | Veneer | Panel per | Panel per | Open | Close |
| | | Veneer | (Actual | Glue line | Glue line | Assembly | Assembly |
| Resin | Panel | Mass | Resin | (Actual Resin, | (Resin Solids, | Time | Time |
| Type | ID | (g) | Weight, g) | g/m²) | g/m²) | (minute) | (minute) |
| Chitosan | G1-1 | 53.13 | 4.76 | 102.75 | 23.98 | 3.58 | 21.37 |
| (2%) + UF | G1-2 | 53.60 | 4.97 | 107.29 | 25.03 | 4.20 | 21.37 |
| resin | G2-1 | 51.68 | 5.01 | 219.54 | 51.23 | 5.10 | 7.00 |
| (2:1) | G2-2 | 51.55 | 5.09 | 228.18 | 53.24 | 5.04 | 7.00 |
| Chitosan | H1-1 | 52.55 | 5.93 | 128.01 | 57.18 | 4.32 | 19.51 |
| (2%) + UF | H1-2 | 52.67 | 5.76 | 124.34 | 55.54 | 4.08 | 19.51 |
| resin | H2-1 | 51.56 | 5.54 | 244.15 | 109.05 | 5.17 | 7.18 |
| (1:2) | H2-2 | 52.38 | 5.46 | 240.91 | 107.61 | 5.07 | 7.08 |
| UF resin | J1-1 | 51.55 | 3.42 | 73.83 | 48.73 | 6.00 | 16.3 |
| control | J1-2 | 51.92 | 4.20 | 90.67 | 59.84 | 6.12 | 16.3 |
| | J2-1 | 50.63 | 7.47 | 161.26 | 106.43 | 5.13 | 6.00 |
| | J2-2 | 51.16 | 7.38 | 159.31 | 105.15 | 5.20 | 6.00 |
| PF resin | L1-1 | 53.08 | 4.92 | 106.21 | 53.10 | 6.11 | 14.37 |
| control | L1-2 | 54.19 | 4.86 | 104.91 | 52.46 | 5.05 | 14.37 |
| | L2-1 | 53.39 | 9.60 | 207.24 | 103.62 | 4.98 | 6.12 |
| | L2-2 | 53.26 | 9.36 | 202.06 | 101.03 | 5.00 | 6.12 |

Panel ID: G = Plywood made with the chitosan-reinforced UF resin at 2:1 ratio; H = Plywood made with the chitosan-reinforced UF resin at 1:2 ratio; J = Plywood made with the control UF resin; L = Plywood made with the control PF resin.

TABLE 5
Manufacturing parameters for 2-ply plywood panels with different resins

| | |
|---|---|
| Veneer dimension | 148 mm × 313 mm × 1.5 mm |
| Target glue spread on face veneer | 7.7 to 8.3 g |
| Glue application method | 3″ roller system with a ⅛″ thick |
| | foam for smooth surfaces |
| Area of pressure on panel | 185296 mm² |
| Gauge pressure on Viceroy press | 367 psi |
| 24″ × 24″ | |
| Press time | 3 min + 20 sec. |
| Press temperature | 140° C. |

TABLE 6
Dry lab-shear test results of 2-ply plywood panels made with different
types of resins

| | Resin | Spread Rate | Lap-Shear | | Wood | |
|---|---|---|---|---|---|---|
| | Solid | (g/m², based on | Strength | | Failure | |
| Resin Type | (% wt.) | solids) | kPa | SD | % | SD |
| Chitosan | 24.0 | 24.0 | 6809 | 1678 | 15 | 19 |
| (2%) + UF resin | | 25.0 | 5632 | 750 | 49 | 38 |
| (2:1) | | 51.2 | 6187 | 1501 | 90 | 14 |
| | | 53.2 | 6106 | 1037 | 88 | 19 |
| Chitosan | 45.4 | 57.2 | 6547 | 1894 | 75 | 45 |
| (2%) + UF resin | | 55.5 | 5616 | 1104 | 93 | 26 |
| (1:2) | | 109.1 | 5235 | 1494 | 61 | 49 |
| | | 107.6 | 5490 | 1059 | 100 | 0 |
| UF resin control | 66.8 | 48.7 | 4231 | 965 | 14 | 25 |
| | | 59.8 | 4479 | 1031 | 21 | 34 |
| | | 106.4 | 4168 | 1555 | 4 | 9 |
| | | 105.1 | 3591 | 1103 | 0 | 0 |
| PF resin control | 50.0 | 53.1 | 6689 | 1854 | 100 | 0 |
| | | 52.5 | 6648 | 849 | 100 | 0 |
| | | 103.6 | 6600 | 1416 | 100 | 0 |
| | | 101.0 | 5910 | 1141 | 100 | 0 |

Lap-shear strength or wood failure data is an average of 12 test specimens.
SD: standard deviation

TABLE 7
Wet lab-shear test results of 2-ply plywood panels made with different
types of resins

| | | Spread rate | | | | |
|---|---|---|---|---|---|---|
| | Resin | g/m² | Lap-Shear | | Wood | |
| | Solid | (based on | Strength | | Failure | |
| Resin Type | (% wt.) | solids) | kPa | SD | % | SD |
| Chitosan (2%) + UF | 24.0 | 24.0 | 3782 | 1208 | 58 | 51 |
| resin (2:1) | | 25.0 | 4167 | 574 | 88 | 30 |
| | | 51.2 | 5088 | 981 | 100 | 0 |
| | | 53.2 | 4353 | 1000 | 100 | 0 |
| Chitosan (2%) + UF | 45.4 | 57.2 | 5456 | 1246 | 100 | 0 |
| resin (1:2) | | 55.5 | 4375 | 810 | 100 | 0 |
| | | 109.1 | 5184 | 1255 | 100 | 0 |
| | | 107.6 | 4511 | 861 | 100 | 0 |
| UF resin control | 66.8 | 48.7 | 1929 | 486 | 0 | 0 |
| | | 59.8 | 2228 | 416 | 1 | 3 |
| | | 106.4 | 1599 | 640 | 0 | 0 |
| | | 105.1 | 2311 | 881 | 0 | 0 |
| PF resin control | 50.0 | 53.1 | 4152 | 837 | 81 | 38 |
| | | 52.5 | 4282 | 644 | 59 | 34 |
| | | 103.6 | 4604 | 868 | 46 | 45 |
| | | 101.0 | 4036 | 1221 | 57 | 39 |

Lap-shear strength or wood failure data is an average of 12 test samples after 48-hour soaking in water at 20° C.
SD: standard deviation

### Example IV

### Formulation of Chitosan-Reinforced Resin Mixtures with the Use of Wheat Flour and Catalyst

Six formulations of chitosan-reinforced urea-formaldehyde adhesive mixtures were prepared with the chitosan solution (Example I) and a urea-formaldehyde resin (Example II) as described above by adding different proportions of wheat flour and a catalyst NH₄Cl inside (Table 8).
1) Formulation A contained 17.9% (solid basis) of wheat flour, 1% (solid basis) of catalyst (NH₄Cl) (solid basis) and 41.6% (solid basis) of UF resin. The solid content of this adhesive mixture was 60.5% (solid basis) with a viscosity of 1534 cps.
2) Formulation B contained 17.9% (solid basis) of wheat flour, 2% (solid basis) of catalyst (NH₄Cl) (solid basis) and 41.3% (solid basis) of UF resin. The solid content of this adhesive mixture was 61.2% (solid basis) with a viscosity of 1592 cps.
3) Formulation C contained 8.95% (solid basis) of wheat flour, 0.47% (solid basis) of chitosan, 1% (solid basis) of catalyst (NH₄Cl) (solid basis) and 44.4% (solid basis) of UF resin. The solid content of this adhesive mixture was 54.82% (solid basis) with a viscosity of 6800 cps.
4) Formulation D contained 8.95% (solid basis) of wheat flour, 0.57% (solid basis) of chitosan, 2% (solid basis) of catalyst (NH₄Cl) (solid basis) and 42.4% (solid basis) of UF resin. The solid content of this adhesive mixture was 53.92% (solid basis) with a viscosity of 6250 cps.
5) Formulation E contained 0.23% (solid basis) of chitosan, 1% (solid basis) of catalyst (NH₄Cl) (solid basis) and 52.6% % (solid basis) of UF resin. The solid content of this adhesive mixture was 53.83% (solid basis) with a viscosity of 9200 cps.
6) Formulation F contained 0.29% (solid basis) of chitosan, 2% (solid basis) of catalyst (NH₄Cl) (solid basis) and 50.8% (solid basis) of UF resin. The solid content of this adhesive mixture was 53.09% (solid basis) with a viscosity of 7700 cps.

By adding chitosan in UF resins, the viscosity of the resin mixtures was significantly increased (Table 8, formulations C to F).

TABLE 8
Summary of glue formulation and application on 3-ply plywood panels

| | Catalyst | | | | | |
|---|---|---|---|---|---|---|
| | NH₄Cl | Wheat | Chitosan | | | |
| | Content | Flour | Content | Solid UF | | |
| | Based on | Based on | Based on | Content in | Total Solid | Viscosity |
| Resin | Liquid UF | Liquid UF | Liquid UF | Glue | Content of | of Resin |
| Formulation | Resin | Resin | Resin | Mixture | Glue Mix | Mixture |
| Code | (%) | (%) | (%) | (%) | (%) | (cps) |
| IV-A | 1 | 17.9 | 0 | 41.6 | 60.50 | 1534 |
| IV-B | 2 | 17.9 | 0 | 41.3 | 61.20 | 1592 |
| IV-C | 1 | 8.95 | 0.47 | 44.4 | 54.82 | 6800 |
| IV-D | 2 | 8.95 | 0.57 | 42.4 | 53.92 | 6250 |
| IV-E | 1 | 0 | 0.23 | 52.6 | 53.83 | 9200 |
| IV-F | 2 | 0 | 0.29 | 50.8 | 53.09 | 7700 |

### Example V

### Testing of 3-Ply Plywood Panels Made with the Adhesive Mixtures

Yellow birch veneer strips (1.5 mm thick×120 mm wide×240 mm long) were cut from fresh yellow birch logs with the long direction being parallel to the wood grains. The resins prepared above were applied to one side of each face layer with a spread rate target at 214 g/m². Table 9 summarizes the plywood panels manufacturing parameters. After manufacturing, the panels were conditioned at 21° C. and 50% relative humidity until consistent moisture content was reached. These 3-ply plywood samples were then cut into testing specimen size (25 mm wide×80 mm long) for plywood shear test. For each panel, the half were cut in pulled open and the other half were cut in pulled closed. Equal amount of specimens (pulled opened and pulled closed) from same panels are distributed for testing at dry and wet condition.

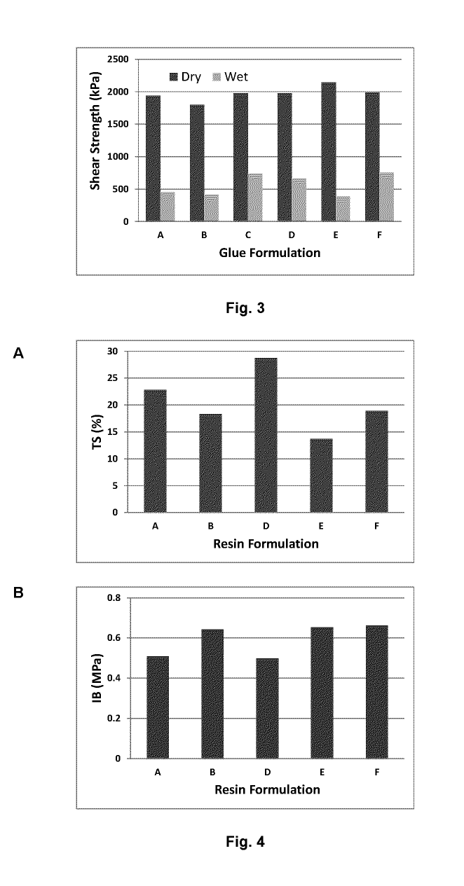

The 3-ply plywood were tested according to ASTM D906, and the results are summarized in Table 10 and FIG. 3. These results showed that increasing amount of catalyst (NH₄Cl) from 1% to 2% did not significantly affect both dry and wet bonding strengths of UF resins (formulations A & B). Wheat flour was able to be reduced or replaced by adding a small amount of chitosan in the formulations with increased bonding quality (formulations C, D, E & F). The 3-ply plywood panels made with the chitosan-reinforced UF resin mixture at a half dosage of wheat flour (8.95%), 0.47% of chitosan and 1% of catalyst (formulation C) resulted in an increase of dry strength from 1942 kPa (formulation A) to 1974 kPa and wet strength from 454 kPa (formulation A) to 743 kPa (Table 10). Whereas those 3-ply plywood panels made with the chitosan-reinforced UF resin mixture without wheat flour but adding 0.29% of chitosan and 2% of catalyst (formulation F) resulted in an increase of dry shear strength from 1799 kPa (formulation B) to 1989 kPa and wet shear strength from 419 kPa (formulation B) to 757 kPa. These data indicated that the water resistance of the UF resin was improved by adding chitosan inside formulations.

TABLE 9
Plywood panel manufacturing conditions

| Wood species | Yellow birch | |
|---|---|---|
| Thickness of veneer | 1.5 | mm |
| plywood | 3-ply plywood | |
| Resin spread rate on face ply | 230 | g/m² |
| Temperature | 150° | C. |
| Pressure | 1500 | kPa |
| Time | 3 | min |
| Release pressure | 30 | sec |

TABLE 10
Lab-shear test results of 3-ply plywood panels made
with different chitosan-reinforced resins

| | | | | | Average |
|---|---|---|---|---|---|
| | Glue | | | | Wet |
| | Average | Average Dry | Average Dry | Average | Shear |
| Resin | Spread | Shear | Shear Wood | Wet Shear | Wood |
| Formulation | Rate | Strength | Failure | Strength | Failure |
| Code | (g/m²) | (kPa) | (%) | (kPa) | (%) |
| IV-A | 228 | 1942 (272) | 18 (17) | 454 (412) | 3 (6) |
| IV-B | 229 | 1799 (178) | 14 (5) | 419 (374) | 3 (5) |
| IV-C | 200 | 1974 (256) | 15 (7) | 743 (478) | 6 (12) |
| IV-D | 224 | 1978 (290) | 18 (16) | 664 (443) | 7 (12) |
| IV-E | 181 | 2143 (388) | 21 (11) | 389 (423) | 1 (4) |
| IV-F | 185 | 1989 (335) | 19 (13) | 757 (449) | 4 (6) |

Values in brackets are standard deviations;
Resin formulation code refers to Table 8

### Example VI

### Manufacturing Particleboard with Chitosan-Enhanced Urea-Formaldehyde Resin Mixtures

Spruce, pine and fir (SPF) wood particles were obtained from a local particleboard mill. A 24 in.×24 in. Viceroy Standard Press was used to press boards. Detailed information on board manufacturing conditions is presented in Table 11.

UF resin was collected from a local resin supplier, with solid content of 66.8%.

A series of particleboard panels were manufactured with use of a catalyst NH₄Cl as described below:
VI-A Panels were made of actual UF resin (66.8% wt. of solid content) plus 1% NH₄Cl (on UF solid basis) as face resin and UF resin plus 2% NH₄Cl (on UF solid basis) as core resin.
VI-B Panels were made of 3 parts of UF resin plus 1 part of 2% chitosan solution by weight (the solid of resin mixture is 50.8% by weight, and the ratio of chitosan solid to UF solid is 1:100) and plus 1% NH₄Cl (on UF solid basis) as face resin and 3 parts of UF resin plus 1 part of 2% chitosan solution and plus 2% NH₄Cl (on UF solid basis) as core resin.
VI-D Panels were made of 3 parts of UF resin plus 1 part of 2% chitosan solution by weight as both face and core resin without adding catalyst for comparison with those with catalyst.
VI-E Panels were made of actual UF resin plus 1% chitosan powder (on UF solid basis) and plus 1% NH₄Cl (on UF solid basis) as face resin and UF resin plus 1% chitosan powder (on UF solid basis) and plus 2% NH₄Cl (on UF solid basis) as core resin.
VI-F Panels were made of actual UF resin plus 2% chitosan powder (on UF solid basis) and plus 1% NH₄Cl (on UF solid basis) as face resin and UF resin plus 2% chitosan powder (on UF solid basis) and plus 2% NH₄Cl (on UF solid basis) as core resin.

TABLE 11
General particleboard manufacturing conditions

| Board dimension | 20 in. × 20 in. × ½ in. |
|---|---|
| | (510 mm × 510 mm × 12.7 mm) |
| Board construction | Three layers |
| Mass distribution | Homogenous panel |
| Wood species | Commercial mixed species |
| Support | Caul plates at the bottom and on the top |
| Target mat MC | 5-6% (after blending or after drying) |
| Wax emulsion | 0.5% (solids on a dry wood basis) |
| Resin | 6% (solid based on a dry wood basis) |
| Catalyst | 0.5% ammonium chloride for UF resin |
| | (solids on resin solids) |
| Board target density | 688 kg/m³ (43 lb/ft³) (OD basis) |
| Press temperature | 185° C. (surface of platen) |
| Total press time | 180 seconds (daylight to daylight) |
| Press closing time | 20 seconds |
| Degas time | 20 seconds |
| Replicate | 2 |

All particleboards were conditioned at 65% RH/23° C. for more than three (3) weeks till reaching the equilibrium moisture content (EMC) and then evaluated for internal bond (IB) strength, modulus of rupture (MOR), modulus of elasticity (MOE) and thickness swelling (TS)/water absorption (WA) after soaking for 24 hours in water according to ASTM D1037-06 standard.

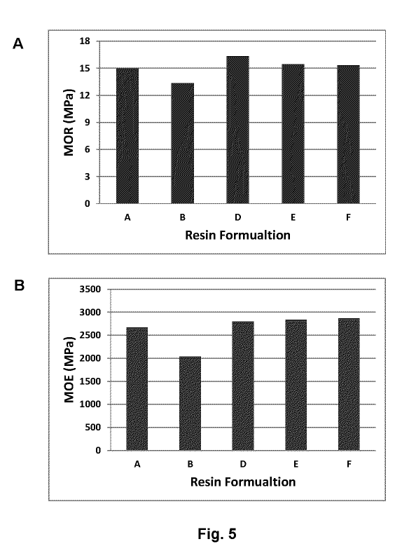

The test results are presented in Table 12 and FIGS. 4A, 4B, 5A and 5B. All formulations of chitosan-UF adhesives (ID-B, ID-D and ID-F) had better IB strength and water resistance properties than UF control resin (ID-A). Panels (ID-D) made of UF resin plus 1% chitosan powder and 1% catalyst (NH₄Cl) as face resin and UF resin plus 1% chitosan powder and 2% catalyst (NH₄Cl) as core resin had the best physical and mechanical properties and lowest rates of water absorption and thickness swelling.

TABLE 12
Physical and mechanical properties of particleboard panels made
of chitosan-reinforced UF resins

| | MC | TS | WA | IB | MOR | MOE |
|---|---|---|---|---|---|---|
| Panel ID | (%) | (%) | (%) | (MPa) | (MPa) | (MPa) |
| VI-A | 8.2 | 22.8 | 56.7 | 0.51 | 14.97 | 2671 |
| VI-B | 8.2 | 18.3 | 47.1 | 0.64 | 13.35 | 2036 |
| VI-C | 8.1 | 28.7 | 70.4 | 0.50 | 16.32 | 2794 |
| VI-D | 8.1 | 13.7 | 34.0 | 0.65 | 15.44 | 2833 |
| VI-F | 8.3 | 18.9 | 49.5 | 0.66 | 15.32 | 2865 |

Panel ID refers to description of different resin formulations in paragraph 75

### Example VII

### Tacking Improvement in Particleboard Manufacturing by Using Chitosan-Reinforced UF Resin

Three UF resin formulations were used for tacking evaluation in particleboard mat manufacturing:
VII-A. Face resin: 3 parts of UF resin+1 part of 2% chitosan solution with 1% catalyst (20% NH₄Cl); Core resin: 3 parts of UF resin+1 part of 2% chitosan solution with 2% catalyst (20% NH₄Cl).
VII-B. Face resin: UF resin+0.99% chitosan powder (on UF solid)+1% NH₄Cl at 20% (solid on UF solid; Core resin: UF resin+0.95% chitosan powder (on UF solid)+2% NH₄Cl at 20% (solid on UF solid).
VII-C. UF resin control; Face resin: UF resin+1% NH₄Cl at 20% (solid on UF solid); Core resin: UF resin+2% NH₄Cl at 20% (solid on UF solid).

Adhesive loading (% wt.) was 8% on a solids basis. Three layers with face and core UF (using different amounts of NH₄Cl face and core layers) were made in making particleboard mat. The tack test was duplicated. The test results are present in Table 13.

TABLE 13
Tack test (Falling distance) in making particleboard mat

| | | | | Average |
|---|---|---|---|---|
| | Face Moisture | Core Moisture | | Falling |
| | Content | Content | Falling Distance | Distance |
| Resin | (%) | (%) | (cm) | (cm) |
| VII-C | 9.9 | 6.5 | 13.8 (2.6) | 13.8 |
| | 9.4 | 7.0 | 13.8 (1.8) | (2.1) |
| VII-A | 9.9 | 6.3 | 15.6 (2.3) | 17.7 |
| | 10.2 | 7.5 | 20.4 (2.7) | (3.4) |
| VII-B | 9.7 | 6.8 | 13.7 (2.6) | 14.1 |
| | 10.1 | 6.4 | 14.4 (1.6) | (2.1) |

It was found that adding 1 part of 2% chitosan solution into 3 parts of liquid UF resin, corresponding to 0.66 wt % solid chitosan in the liquid resin improves the resin tack by 28% in terms of increased particleboard mat falling distance (with an in-house test method for characterizing resin tacking).

While the present disclosure has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

1. An adhesive resin comprising
a) unmodified chitosan; and
b) a urea-formaldehyde (UF) resin.

2. The adhesive resin of claim 1, further comprising wheat flour.

3. The adhesive resin of claim 1, further comprising a catalyst.

4. The adhesive resin of claim 1, further comprising phenol-formaldehyde (PF) or melamine-formaldehyde (MF).

5. The adhesive resin of claim 1, further comprising polyvinyl acetate (PVA) adhesives.

6. The adhesive resin of claim 1, comprising two parts of the chitosan solution (2% w/v) for one part of UF resin (volume to volume).

7. The adhesive resin of claim 1, comprising one part (volume to volume) of chitosan in solution (2% w/v) for two parts of UF resin.

8. The adhesive resin of claim 1, comprising a ratio of 1:2 or 2:1 of chitosan-UF resin.

9. The adhesive resin of claim 1, comprising one part (volume to volume) of chitosan in solution (2% w/v) for three parts of a liquid UF resin.

10. The adhesive resin of claim 3, wherein the catalyst is NH₄Cl.

11. The adhesive resin of claim 1, wherein said chitosan is from shells of marine crustaceans or from cell wall of fungi.

12. The adhesive resin of claim 11, wherein the crustaceans are crabs, lobsters or shrimps.

13. The adhesive resin of claim 1, said resin comprising a viscosity of up to 900 CP.

14-16. (canceled)

17. A fibrous material comprising the adhesive resin of claim 1.

18. The fibrous material of claim 17, wherein said fibrous material is a paper, wood, plywood, strandboard, particleboard, fibreboard or a combination thereof.

19. A method of producing an adhesive resin comprising:
a) dissolving chitosan in an acid to produce a chitosan solution; and
b) mixing said chitosan solution to an urea-formaldehyde (UF) resin.

20. The method of claim 19, wherein the chitosan is dissolved in acetic acid.

21. The method of claim 19, 2% (w/V) of chitosan is dissolved in 2-10% (v/v) 1N acetic acid.

22. The fibrous material of claim 18, wherein the fibrous material is a plywood comprises a strength of up to 6809 kPa.
